(19) United States
(12) Patent Application Publication
(10) Pub. No.: US 2009/0155037 A1
(43) Pub. Date: Jun. 18, 2009

(54) Wheelchair lift apparatus

(75) Inventors: Christian Sahr, Calden (DE); Alexander Heckel, Schwalmstadt (DE)

Correspondence Address: PYLE & PIONTEK, LLC, 221 N LASALLE STREET , ROOM 1207, CHICAGO, IL, 60601, US

(73) Assignee: Hubner Transportation GmbH

(21) Appl. No.: 12/284,000

(22) Filed: Sep. 17, 2008

(30) Foreign Application Priority Data
Dec. 12, 2007 (DE) 10 2007 059 943.0

(51) Int. Cl. A61G 3/06; B60P 1/44; B60P 3/06

(52) U.S. Cl. 414/544

(57) ABSTRACT

The present invention is directed to a wheelchair lift apparatus (1) for mounting to a vehicle, e.g., to a bus or a railway car, comprising a platform (2) having a bridge plate (3) pivotally hinged thereon, said platform (2) being retained by at least one carriage (5), said carriage (5) being carried for travel into and out of a housing (50) of the vehicle, said carriage (5) with the platform (2) being connected by two hinge arms (4) disposed on either side of the platform, said carriage (5) comprising at least one drive (6) for connection to the hinge arms (4), said bridge plate being pivotally carried in the platform (2) through a pivot axis (20), a linkage system (14) being provided, which is on the one side positively coupled to the one hinge arm (4) and which is, on the other side, in operative communication with the pivot axis (20) for pivoting the bridge plate, said linkage system (14) being connected via a connecting arm (42) to a positive guide (43) guided for longitudinal displacement in the platform for guiding a guide member (45) of a hand rail (40) for folding said hand rail (40) up and down.

### CROSS-REFERENCE TO RELATED APPLICATIONS

This application claims Priority from German Application No. DE 10 2007 059 943.0-24 filed on 12 Dec. 2007

### FIELD OF THE INVENTION

The present invention relates to a wheelchair lift apparatus for mounting to a vehicle, e.g., to a bus or a railway car, comprising a platform having a bridge plate pivotally hinged thereon, said platform being retained by at least one carriage, said carriage being carried for travel into and out of a housing of the vehicle, said carriage with the platform being connected by two hinge arms disposed on either side of the platform, said carriage comprising at least one drive for connection to the hinge arms, said bridge plate being pivotally carried on the platform through a pivot axis.

### DESCRIPTION OF THE PRIOR ART

The Dutch patent document 1021891 is directed to what is referred to as a wheelchair lift apparatus as it is mounted to vehicles, in particular to busses, in order to allow wheelchair users to board the bus. For this purpose, a housing is provided on the car body, said housing accommodating a carriage which most of the time is adapted to be moved out of the housing across the longitudinal axis of the vehicle, the platform being hinged to the carriage with two parallely extending hinge arms. Through the hinge arms, the platform can be lowered or raised with the help of a drive, more specifically with the help of at least one piston and cylinder drive that is disposed in the carriage and acts onto a tie bar connecting the two hinge arms.

Boarding a bus or a railway car is by climbing steps. The platform is raised in the vertical direction only so that there is still a gap to be bridged between the end of the platform and the floor of a bus for example, which is due to the steps. The so-called bridge plate serves this purpose.

As already mentioned above, there is provided a drive that causes the carriage to which the bridge plate is hinged to move in or out.

Another drive is needed to cause the hinge arms to raise or lower the bridge plate. According to the prior art mentioned above, the Dutch Patent 1021891, another drive is needed to pivot said bridge plate. More precisely, there is provided a piston and cylinder drive therefor, said piston and cylinder drive being affixed off center to the pivot axis of the bridge plate, thus causing the bridge plate to move from a horizontal position in the retracted position of the platform via a vertical position back into a horizontal position. Separate drives for the right and the left hand rail respectively are provided for raising the hand rails on either side of the ramp platform.

The previously described wheelchair lift apparatus has proved efficient in daily use. However, it is quite expensive, which is in particular due to the fact that there are provided at least five drives for the platform, the bridge plate and the carriage to be capable of executing the movements they are intended to perform. One drive is provided for moving the carriage out, two parallel acting piston and cylinder drives are provided to lower and raise the platform and two piston and cylinder drives are provided to pivot the bridge plate; additional drives are provided for the hand rails.

A wheelchair lift apparatus of the type mentioned herein above is known from WO 94/27546, wherein there is also provided a bridge plate. This bridge plate is pivotally carried in the frame of the ramp platform. The bridge plate is connected through the pivot lever and the rod articulated thereto to the one hinge arm, which, in connection with a second hinge arm as a parallelogram element, finally makes sure that the platform is raised. This means that the bridge plate is positively controlled by the pivot lever and the rod in connection with the hinge arm with respect to the pivotal movement of the bridge plate. Especially when the platform is brought into a position relative to the vehicle that makes it possible to retract the ramp platform, the bridge plate is brought into a position pointing slightly diagonally away from the ramp platform as can be seen in FIG. 2 of the cited document. In the position shown in FIG. 2, the platform is retracted. When the platform is lowered, by contrast, the bridge plate is brought into a vertical position. Since the height of the mounting enclosure in the vehicle floor, which accommodates the ramp platform, is quite low, the bridge plate also can only have a quite low height in the inclined position. Otherwise, the platform could not be retracted. This is particularly relevant if, to bridge the gap from the rear edge of the ramp platform to the vehicle floor, a bridge plate of greater length is needed as it is the case for example when s not only one stair step must be bridged but when, as it is often the case, the gap is due to two or three stair steps. With a construction according to the cited document, such gaps can no longer be bridged or such a ramp platform with the bridge plate being slightly pivoted away could no longer be lo retracted into the mounting enclosure of the vehicle because the bridge plate is much too long, thus protruding from the mounting enclosure.

Moreover, it must be made certain that immediately after the ramp platform has been deployed, the persons in the bus are prevented from stepping onto the ramp platform. It must also be made certain that the wheelchair user will not be capable of rolling off the ramp platform before the ramp platform, which is being raised, reaches its end position in which the wheelchair user can get inboard. This means that in the very moment the ramp platform is deployed from the mounting enclosure in the floor of the vehicle, the bridge plate must stand upright in order to prevent, as already explained, persons from stepping from the vehicle onto the extracted ramp platform and it must be further made certain that, when a wheelchair user is on the ramp platform, he is secured against rolling off; this occurs by placing the bridge plate upright on at least one side of the ramp platform.

On the side of the ramp platform located opposite the bridge plate, there is a motor driven ramp steel plate adapted for pivotally moving from a horizontal position into a vertical position. In the vertical position, the ramp steel plate prevents the wheelchair from rolling off the ramp platform; in the horizontal position, it serves to assist the wheelchair user driving onto it. Moreover, on either side of the ramp platform, there are provided hand rails that can be raised by hand.

### BRIEF SUMMARY OF THE INVENTION

It is the object of the invention to allow, on a wheelchair lift apparatus of the type mentioned herein above, both the lifting movement and also the retracting movement of the platform and also the raising of the hand rails, in an economical way, i.e., with the least possible number of drives.

In accordance with the invention, this object is achieved in that, on either side of the platform, there is provided a linkage system that is positively coupled to the hinge arm on the one side and that is in operable communication with the pivot axis for pivoting the bridge plate on the other side, said linkage system being connected through a connecting arm to a positive guide that is guided for longitudinal displacement in the platform for guiding a guide member of a hand rail for folding said hand rail in and out. Said linkage system thereby includes on the one side a fork arm and a push rod and on the other side an abutment rod. Said fork arm adjoins the push rod, which is connected or engages with the pivot axis of the bridge plate. Said push rod engages the pivot axis of the bridge plate insofar for example as the pivot axis has a cam which cooperates with the push rod without there having to be a material-to-material bond. Assuming that the platform is in its deployed condition, i.e., that the platform stands on the floor, and assuming further that the platform is raised from this lower position, the angle relative to the platform will change in the fashion of a parallelogram four bar linkage when the platform is being raised by the hinge arms. As a result, the position of the fork of the hinge arm changes relative to the hinge arm, this simultaneously causing the push rod, which is connected to the hinge arm, to be displaced. I.e., the push rod will move toward or away from the bridge plate in the direction of the pivot axis of the bridge plate. As already discussed, the pivot axis has an erecting cam, said erecting cam abutting the end of the push rod when the platform is being raised; when the platform is raised further, the bridge plate folds backward subject to the position of the platform, thus allowing the wheelchair user to board the vehicle, the bus for example.

It is in this context that the so-called limit stop is provided as a part of the linkage system, which acts onto the pivot axis of the bridge plate. As mentioned, this limit stop is spring-loaded, an abutment cam for the limit stop being provided on the pivot axis, said limit stop incorporating an abutment rod which, upon rotation of the pivot axis, is displaceable against the force of the spring by the abutment cam disposed on the pivot axis. This means that, in the retracted condition of the platform, condition in which the bridge plate rests on the platform, the bridge plate rises by virtue of the spring-loaded limit stop acting on the abutment cam immediately after the platform has been deployed with the help of the already mentioned carriage and adopts a position substantially perpendicular to the platform in which it then remains. In this condition, the platform cannot pivot off backward since the push rod abuts the erecting cam of the pivot axis of the bridge plate, thus preventing the bridge plate from pivoting open over more than approximately 90° when the platform has been put down. It is obvious therefrom that the push rod blocks the pivot axis through the erecting cam. If the platform is then raised, the bridge plate is caused to swing out beyond 90 degrees as far as 180 degrees maximum, this being the position the bridge plate reaches when the platform is level with the vehicle floor.

As already discussed, the linkage system is coupled to a positive guide guided by a connecting arm for longitudinal displacement in the platform. The handrail has a guide member for reception through the positive guide for folding the hand rail in and out. As also already discussed, the linkage system includes a push rod linkage that is positively coupled at one end to the one hinge arm and that is connected to the pivot axis of the bridge plate for rotation of the pivot axis at the other end. The linkage system further includes an abutment rod being part of the limit stop which, upon rotation of the pivot axis through the abutment cam arranged on the pivot axis, is displaceable in particular against the force of a spring. This abutment rod as part of a linkage system is not in communication with the connecting arm that is finally coupled to the positive guide receiving a guide member of the hand rail for folding said hand rail in and out. This means that, upon displacement of the abutment rod, the connecting arm is forcibly also displaced with the bridge plate being pivoted toward the platform as a result thereof especially when, due to retraction of the carriage, the ramp platform is also retracted and the bridge plate strikes the housing of the vehicle, the pivot axis being forcibly rotated hereby. Then, the abutment rod, which is in communication therewith, is also displaced, this resulting in the positive guide, which is configured in a crank-like fashion with a guide groove for receiving the guide member, being displaced lengthwise with respect to the ramp platform. Since the crank is configured to have an arc-shaped cross section, in particular to have a cross section in the shape of a quarter of a circle, with the guide groove extending, as a result thereof, in the crank in the shape of an elongated “Z”, with the guide member resting in the respective end leg of the “Z” in the respective end position, the hand rail is folded in or out as a result thereof. More precisely, the hand rail is folded in by the fact that the guide member, which is for example guided in the guide groove in a roll-like fashion, passes from the lower leg of the elongated “Z” into the upper leg of the stretched “Z” by virtue of the displacement movement of the crank, the hand rail on the top side of the platform folding in thereby, as already discussed.

According to a particular feature of the invention, there is provided that, upon displacement of the abutment rod through rotation of the pivot axis, the connecting arm connected to the abutment rod is biased against the force of a spring so that the hand rails are folded in against the force of this spring. As a result, when the platform is being deployed, as soon as the abutment rod is no longer retained by the bridge plate in its deployed position, the hand rail rises almost by itself by virtue of the bias of the spring that was biased by the connecting arm when the bridge steel plate was being telescoped. I.e., by virtue of the spring biased by the connecting arm, the positive guide, i.e., the crank, is finally returned to its initial position.

According to another feature of the invention, there is provided that the platform comprises a pivotal ramp plate at the end opposite the bridge plate, a drive motor being provided for pivoting the ramp plate.

The ramp plate not only makes it easier for the wheelchair user to drive up the ramp, this ramp plate also serves to prevent the wheelchair user from inadvertently rolling off the ramp while it is lifted. In principle, it is necessary that the ramp steel plate remains in its raised position, meaning in the closed position, as long as the wheelchair user is on the platform. I.e., the control of the pivotal movement of the ramp steel plate must occur irrespective of the position of the ramp. Insofar, positive coupling of the position of the ramp steel plate with the position of the platform is out of question.

Insofar, separate control of the ramp steel plate is only possible through a separate drive.

There is more specifically provided that the platform comprises on either side a beam to which a respective one of the hinge arms is attached, the ramp steel plate being held for pivotal movement by the beams. In the raised condition of the ramp steel plate, a safety pin prevents it from folding down. In order to ensure that the ramp steel plate is not hindered by the safety pin when initiating the folding in operation, the drive motor disposed on the beam comprises a shaft with a thread, the ramp steel plate comprising a mating female thread for receiving the threaded shaft so that the ramp steel plate is displaceable parallel to its longitudinal axis upon rotation of the shaft, the threaded shaft abutting the limit stop of the female thread after the ramp steel plate has been displaced a predetermined length which corresponds approximately to the length of the safety pin protruding beyond the beam, said ramp steel plate being pivoted by the drive motor into the horizontal position upon further rotation of the threaded shaft. This means that, through the longitudinal displacement of the ramp steel plate, the ramp steel plate is at first brought out of engagement with the first safety pin which ensures, as a mechanical lock, that the ramp steel plate will not fold down, with the pivotal movement being performed only then. There is in particular provided that the pivotal outward movement occurs against the force of a spring, in particular of a spiral spring, which is preferably disposed on the other beam of the platform. For pivoting the ramp steel plate inward, the motor receives the signal for reversal, the folding in movement being assisted by the spiral spring. Before, a second safety pin, which retains the ramp steel plate in the folded down position, is retracted for the ramp steel plate to be free to fold in. Upon completion of the folding-in movement, the ramp steel plate is moved to its initial position in the ramp steel plate by the threaded shaft in connection with the female thread and is fixed there by the first safety pin.

The invention will be discussed in closer detail herein after by way of example with reference to the drawings.

### BRIEF DESCRIPTION OF THE DRAWINGS

FIG. 1 shows the platform in a view from the top in a schematic illustration;

FIG. 2 shows a side view, with the platform being put down;

FIG. 2a shows the detail X of FIG. 2 to a larger scale;

FIG. 2b shows the detail Y to a larger scale;

FIG. 2c shows a section through the beam 2b for illustrating the arrangement of the hand rail on the beam;

FIG. 3 shows a position in which the platform is located approximately on the level of the carriage (without hand rail);

FIG. 4 shows a position in which the platform is located on the level of the vehicle floor (without hand rail);

FIG. 5 shows the hand rail on either side of the platform in a slightly folded-down position, the bridge plate being also slightly pivoted toward the platform so as to correspond thereto, together with the details X and Y to a larger scale;

FIG. 6 shows an illustration as shown in FIG. 5 with the details X and Y to a larger scale, the position of the hand rails and corresponding thereto the bridge plate also being pivoted further;

FIG. 7 shows a position of the hand rails shown in FIG. 6 with the details X and Y, with the hand rails being almost folded up;

FIG. 8 shows a position of the hand rails in which the hand rails are completely folded onto the ramp plate together with the details X and Y;

FIG. 9, 9a,b show the positive guide (crank) in three different views;

FIG. 10 shows, together with the details X and Y to an enlarged scale, a view from the front onto the platform with the ramp plate being folded open;

FIG. 10a shows a side view of the beam with the spiral spring;

FIG. 10b shows the connection between threaded shaft and female thread of the ramp steel plate;

FIG. 11 shows an illustration as shown in FIG. 10, the ramp steel plate having already been displaced toward the left, the details X and Y being again shown to an enlarged scale;

FIG. 12 shows a view as shown in FIG. 11 with the ramp steel plate being folded down;

FIG. 12a, b each show corresponding sections of FIG. 12 in a three-dimensional view.

### DETAILED DESCRIPTION OF THE INVENTION

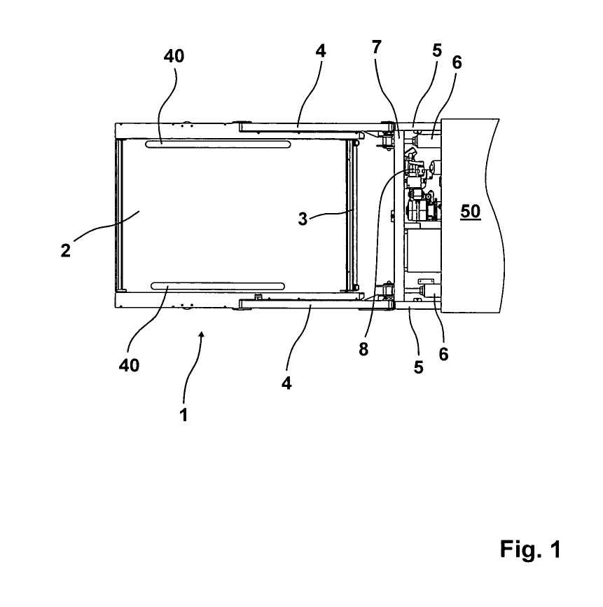

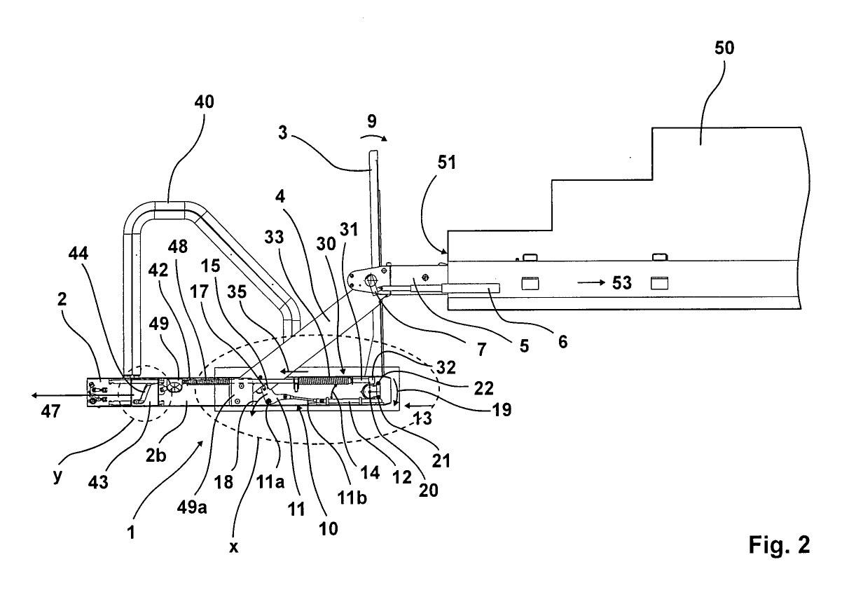

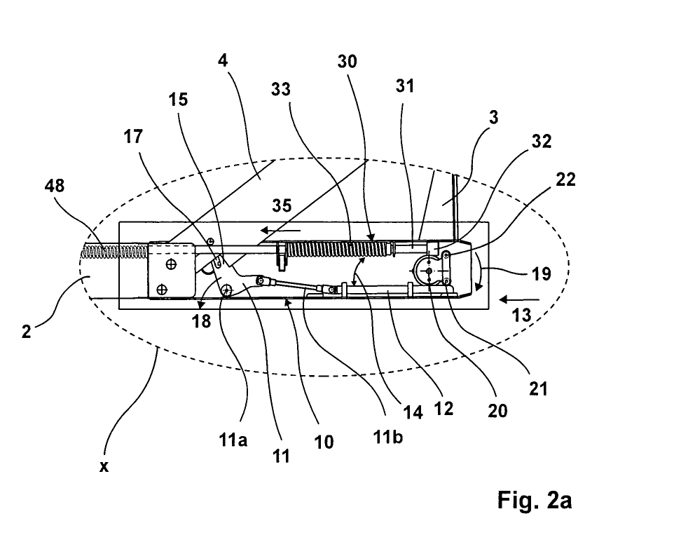

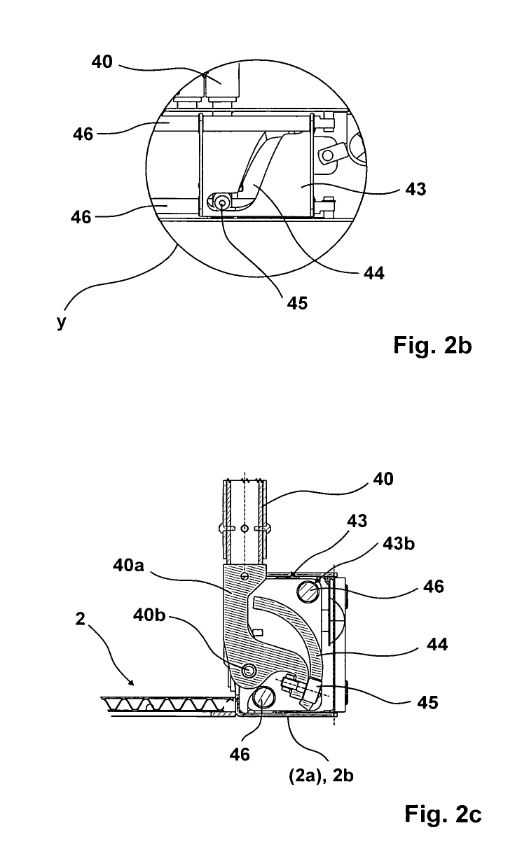

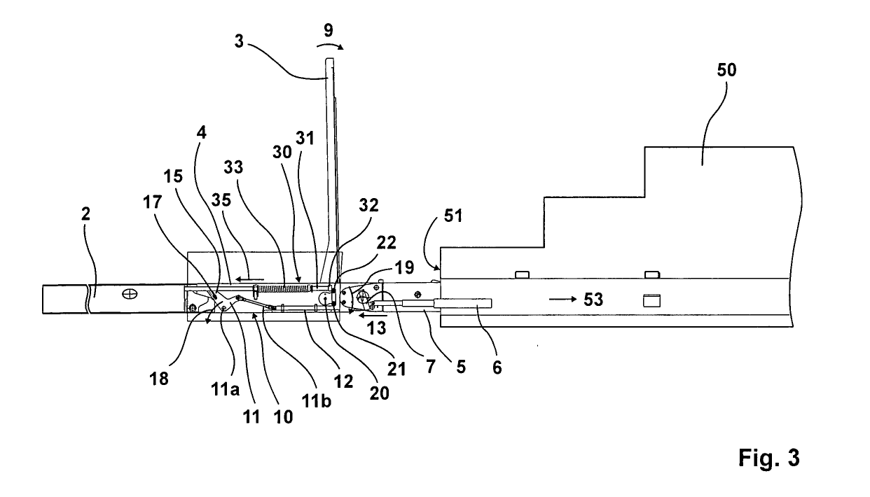

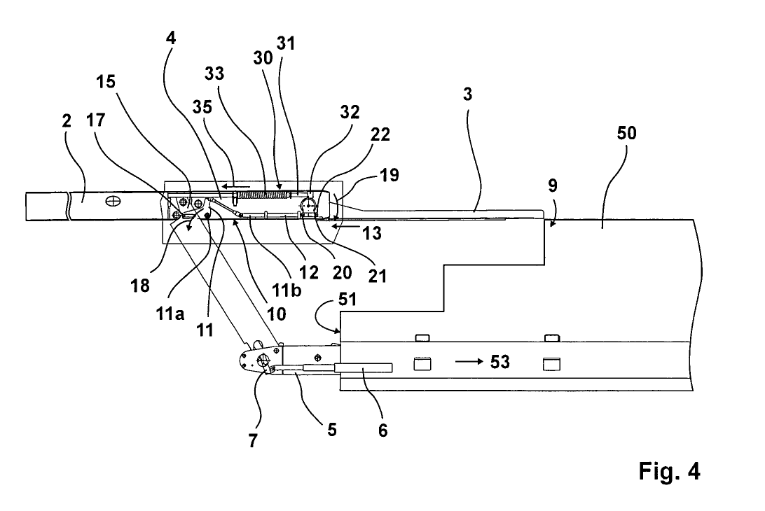

According to FIG. 1, the lift apparatus indicated at 1 comprises the platform 2 which pivotally receives the bridge plate indicated at 3. FIG. 1 also shows the two hinge arms 4 (FIG. 2 and followings), which are arranged on the platform 2 on the one side and which are hinge-linked to the carriage indicated generally at 5 on the other side. The carriage 5 further has the two piston and cylinder drives 6 which are affixed to a tie bar 7 connecting the two hinge arms 4 and which ensure that the platform is put down (FIG. 2) or raised, as can be seen from the FIGS. 3 and 4. To move the carriage into the housing of the bus, there is provided the drive 8.

There is further provided a linkage system 14 incorporating the push rod linkage 10 and the abutment rod 31 of the abutment 30. The push rod linkage 10 incorporates a fork arm 11 that is pivotally carried on the platform 2 through an axis 11a. The fork arm 11 comprises at its one end the push rod 12 via an intermediate member 11b. The push rod 12 is carried on the platform for axial movement pursuant to the arrow 13. At its upper end, the fork arm 11a comprises the fork 15, a pin 17, which is affixed to the hinge arm 4, being rotatably carried in the fork 15.

If one considers now the pivot axis 20 for reception of the bridge plate 3, it appears that the pivot axis 20 comprises at its one, lower end in the mounted condition, an erecting cam 21 and at its other upper end an abutment cam 22. The erecting cam 21 cooperates with the push rod 12; above the push rod 12 there is the limit stop indicated generally at 30. The limit stop 30 incorporates an abutment rod 31 that is displaceable against the force of the spring 33 pursuant to the arrow 35. At its end, the abutment rod 31 comprises an abutment head 32 that cooperates with the abutment cam 22.

In view of FIG. 2 or of FIG. 2a, the functioning of the lift apparatus is as follows with respect to the push rod linkage 10: In the condition shown in FIG. 2, the platform indicated at 2 is located for example on the floor and makes it possible for the wheelchair user to drive onto the platform. Now, with the help of the piston and cylinder drive 6, which is hinged to the tie bar 7 connecting the two hinge arms 4, the platform 3 is caused to pass through a position shown in FIG. 3 to the position shown in FIG. 4. When the platform 2 is being raised, the hinge arms 4 change their position relative to the platform 2. As already explained, the pin 17, which is disposed on the hinge arm 4, and the fork 15 of the fork arm 11 allow for a connection with the push rod 12. When the platform 2 is being raised, the fork 15 moves about the axis 11a, pursuant to arrow 18. The push rod is then pulled toward the platform 2 from the position shown in FIG. 2. In the position shown in FIG. 2, the pivot axis 20 is blocked insofar as the pivot axis 20 rests with its erecting cam 21 on the push rod 12 as this is obvious when reviewing FIG. 2a. If now—as already explained—the push rod 12 is pulled toward the platform, the pivot axis 20 rotates together with the erecting cam 21, which abuts the front side of the push rod 12, pursuant to arrow 19. This makes it possible for the bridge plate to pivot in the direction of the arrow 9, the bridge plate adopting a position shown in FIG. 4 in the end position, thus making it possible for the wheelchair user to board the bus from the platform 2.

Now, the lift apparatus is no longer needed and it must be retracted into the housing 50 in the car body of the bus. For this purpose, the platform is caused to move into a position shown in FIG. 3. The carriage 5 then retracts the platform 2 1o pursuant to arrow 53, with the platform 3 being pivoted in a direction opposite to the arrow 9 when the bridge plate 3 strikes the front side 51 of the housing 50. The abutment head 32 of the abutment rod 31 is thereby displaced by the abutment cam 22 of the pivot axis 20 pursuant to arrow 35, with the Is spring 33 being compressed, meaning biased. This means that in the retracted condition of the platform the bridge plate 3 rests on the platform 2, the spring 33 of the limit stop 30 being biased. As soon as the platform has been deployed, the bridge plate will immediately rise in order to prevent persons waiting in the bus from stepping onto the lowering platform.

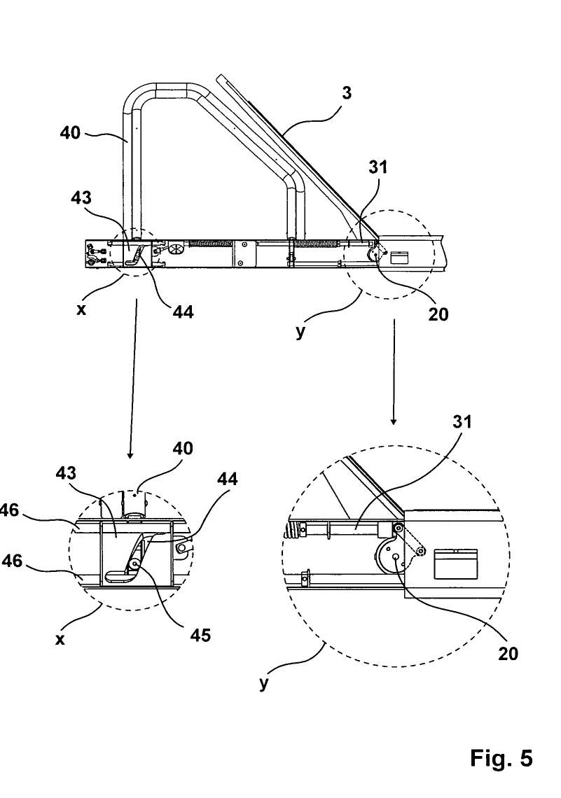

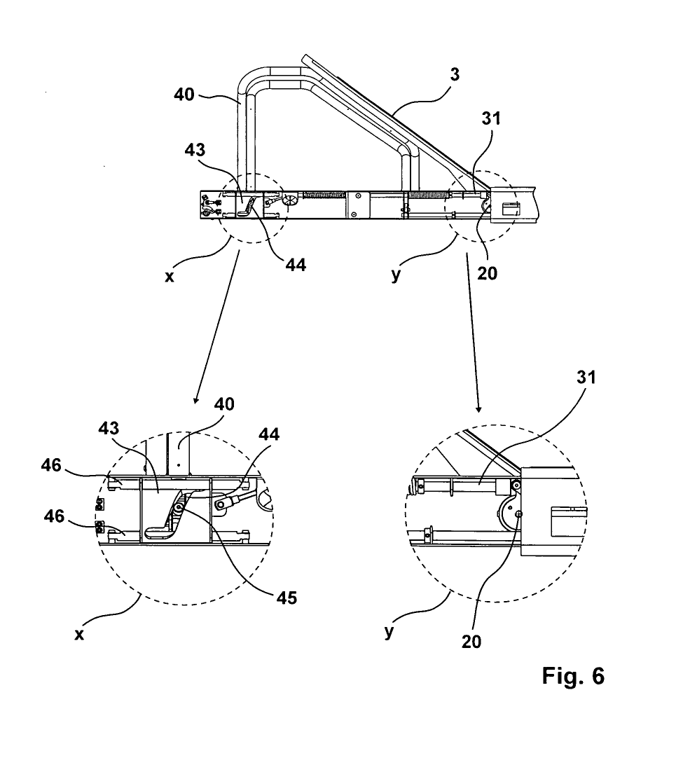

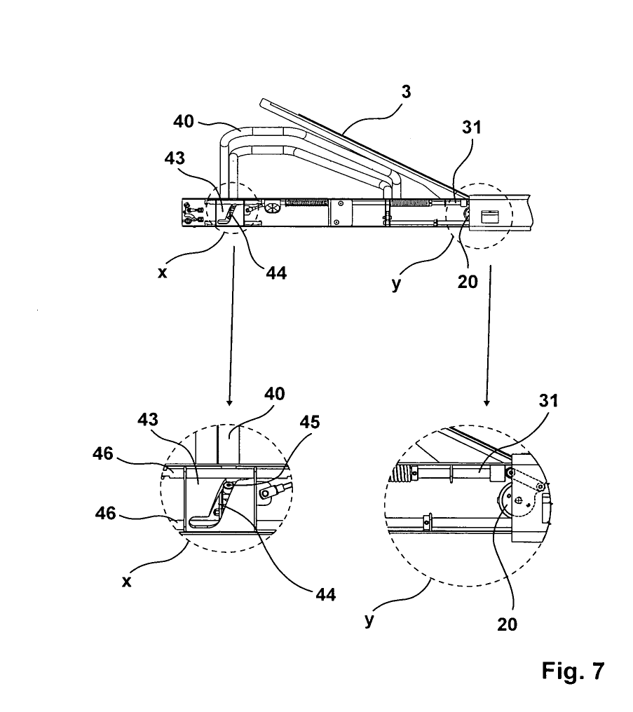

Herein after, the actuation of the hand rails 40 during retraction of the platform into the housing 50 of the car body will be described; the relevant Figures are FIG. 2 as well as FIG. 5 through 9. The drive with the push rod linkage and the fork arm are omitted for the sake of clarity. To begin with, such a hand rail is located on either side of the platform, the movement of the hand rails being the same for folding down or up on either side of the platform. Accordingly, only the folding down of one hand rail on one side will be described herein after. This description will be made in view of FIG. 2 in which the hand rail 40 is in a vertical position. This is the case as long as the ramp is deployed and as long as, corresponding thereto, the bridge plate either allows, in its horizontal position, the wheelchair user to board the bus, or is in the vertical position. The connection of the abutment rod 31 with the connecting arm 42, which in turn is coupled to the positive guide 43, which is configured in a crank-like fashion and has a guiding groove 44, only serves for folding the hand rail 40 up and down. In the groove 44 there is located the guide member 45, which is configured in a roll-like fashion and is fastened to the base of the hand rail. The crank 43, which is carried for displacement on the two rods 46, is configured in an arc shape, in particular in the shape of a quarter of a circle. The hand rail 40 is folded down by displacing the crank 43 pursuant to arrow 47, as this appears herein after with reference to the FIGS. 5 through 8. The base 40a of the hand rail is thereby pivotally carried on the beam 2a, 2b. The roll 45 is spaced from the pivot axis 40b for performing a circular movement when the base 40a is being pivoted, said circular movement correlating with the course of the groove 44.

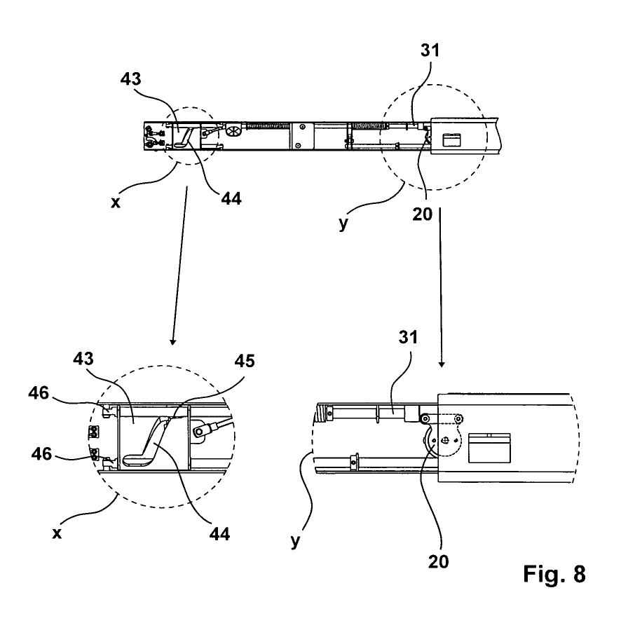

Above it has already been explained that the abutment rod 31 is displaced pursuant to arrow 47. The connecting arm 42 is also displaced in the same direction, so that the spring 48 is being biased. This means that, when the hand rail 40 is being folded down, the crank 43 is displaced pursuant to arrow 47 on the one side, with the spring 48 being biased on the other side since said spring abuts the limit stop 49. At the opposite end, there is located the limit stop 49a. While the hand rail 40 is being folded down, the roll 45 migrates in the groove from the position shown in FIG. 2 into the position shown in FIG. 8. The hand rail 40 is forcibly folded down by the fact that the roll 45 is displaced in the groove 44, namely from the lower leg of the groove 44 in the shape of an elongated Z to the upper leg of the groove in the shape of an elongated Z.

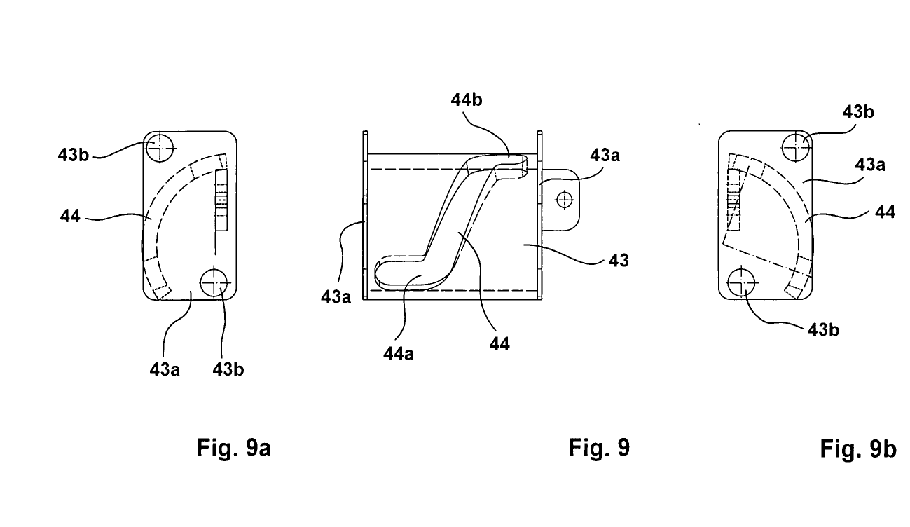

The FIGS. 9, 9a, 9b show the configuration of the crank 43. The crank 43 is configured in the shape of a quarter of a circle and comprises at either end wall plates 43a exhibiting holes 43b for reception through the rods 46. The groove 44 in the shape of an elongated Z has the upper and the lower leg 44a, 44b in which the roll 45 rests in the respective end position.

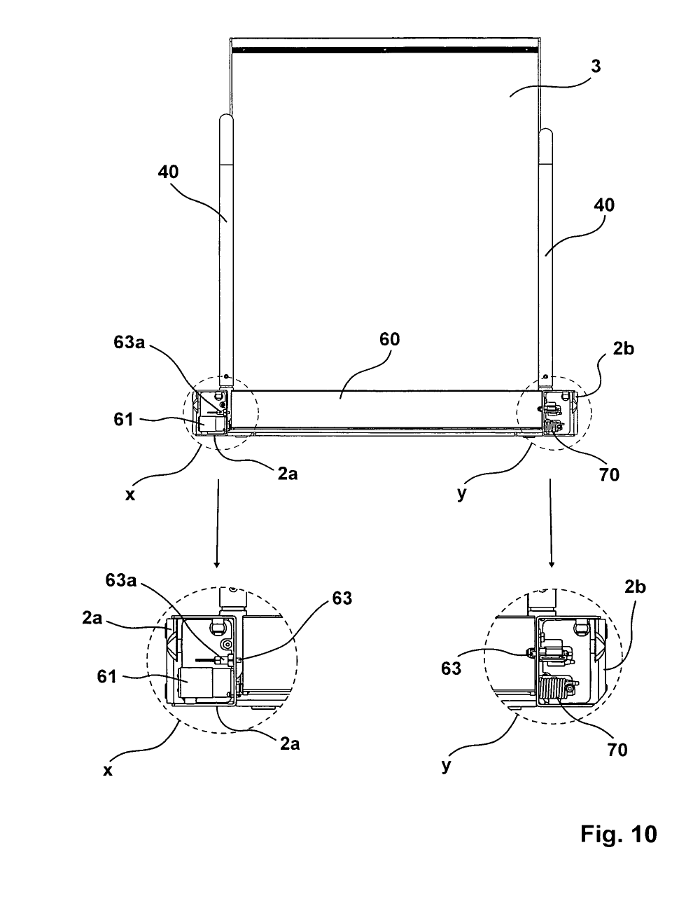

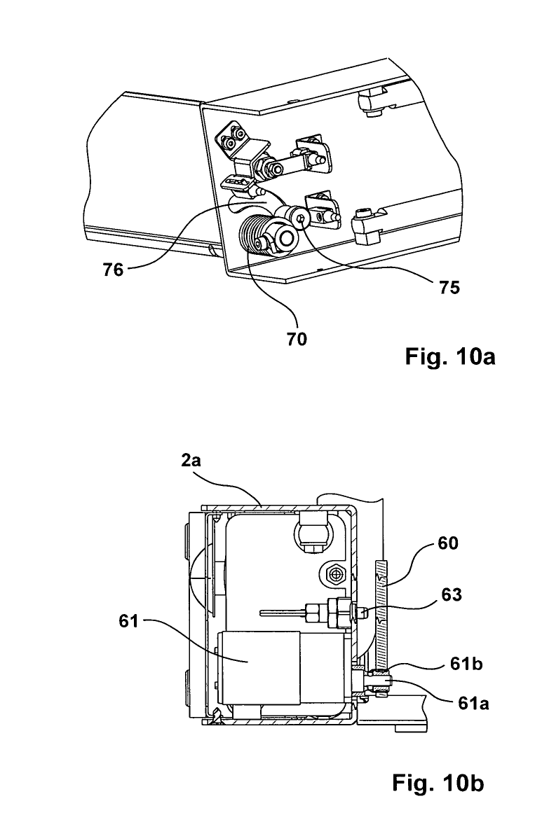

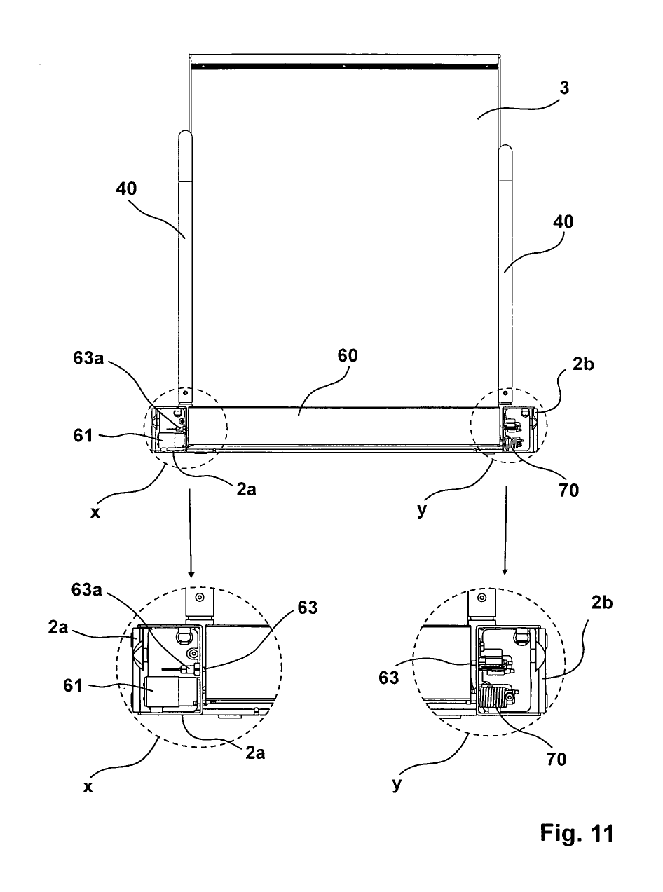

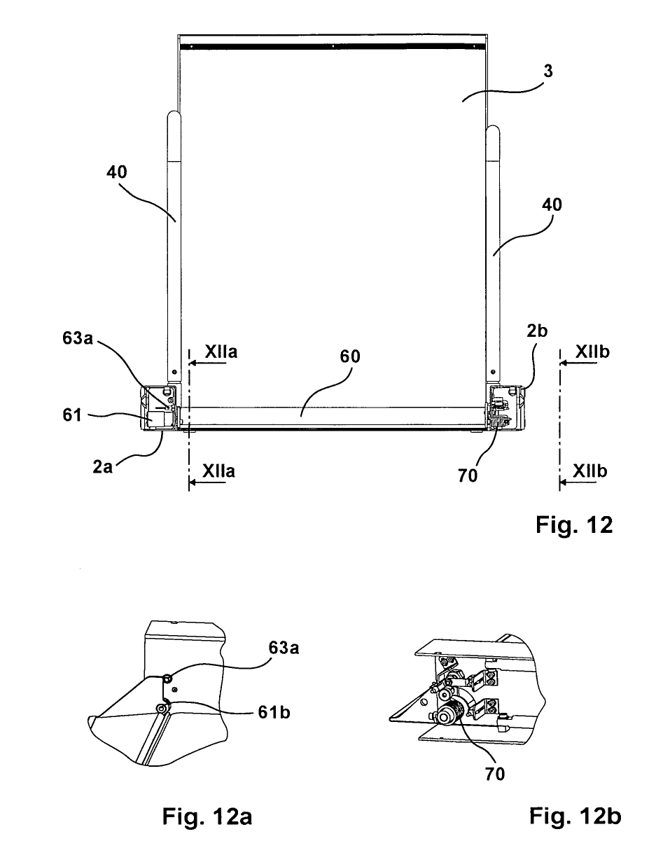

The function of the ramp plate 60 is shown in the FIGS. 10 through 12. The ramp plate 60 is carried in the beams 2a, 2b on the sides of the platform 2. The beams 2a, 2b are configured in a U shape. The beam 2a shows the motor 61, said motor 61 comprising a threaded shaft that cooperates with a female thread in the ramp steel plate (FIG. 10c). Upon rotation of the motor 61, the ramp steel plate 60 is displaced pursuant to arrow Z, as can be seen from FIG. 10 and FIG. 11. The reason therefor is that, upon rotation of the shaft, the ramp steel plate is subject to axial displacement through the threaded shaft 61a of the motor on the one side and the female thread 61b (FIG. 12a) in the ramp steel plate 60 on the other side. Displacement of the ramp steel plate 60 pursuant to arrow Z causes the safety pin 63 to be brought out of engagement with the ramp steel plate. If the threaded shaft 61a abuts the female thread 61b, the ramp steel plate 60 is folded down as can be seen from FIG. 12 or FIG. 12a and FIG. 12b respectively. A second safety pin 63a is loaded which ensures that the folded down ramp steel plate remains in its folded down position. On the side located opposite the motor, there is located, in the region of the beam 2b, a spiral spring 70 that is biased when the ramp steel plate 60 is being biased. In this context, the reader is referred more specifically to FIG. 12b.

On the ramp steel plate 60 there is a driver 75 that is guided in an arc-shaped groove 76 according to the pivotal movement of the ramp steel plate (FIG. 10b, FIG. 12b). On the driver there is the one arm of the spiral spring 70. In the position shown in FIG. 10b, the spring is not biased; in the position shown in FIG. 12b, by contrast, it is biased. To fold the ramp steel plate 16 in, the safety pin 63a is retracted and the ramp steel plate 60 comes free as a result thereof. By virtue of the force of the biased spiral spring, and upon reversing the motor, the ramp steel plate is at first folded up and it is then displaced in the direction opposite the arrow Z by the threaded shaft 65 in connection with the female thread 61b, the safety pin 63 coming again into engagement in the end position, securing the ramp steel plate in the raised position.

We claim:

1. A wheelchair lift apparatus (1) for mounting to a vehicle, e.g., to a bus or a railway car, comprising a platform (2) having a bridge plate (3) pivotally hinged thereon, said platform (2) being retained by at least one carriage (5), said carriage (5) being carried for travel into and out of a housing (50) of the vehicle, said carriage (5) with said platform (2) being connected by two hinge arms (4) disposed on either side of said platform, said carriage (5) comprising at least one drive (6) for connection to said hinge arms (4), said bridge plate being pivotally carried in said platform (2) through a pivot axis (20),
characterized in that a linkage system (14) is provided, which is on the one side positively coupled to the one hinge arm (4) and which is, on the other side, in operative communication with the pivot axis (20) for pivoting the bridge plate, said linkage system (14) being connected via a connecting arm (42) to a positive guide (43) guided for longitudinal displacement in the platform for guiding a guide member (45) of a hand rail (40) for folding said hand rail (40) up and down.

2. The wheelchair lift apparatus as set forth in claim 1, characterized in that the linkage system (14) incorporates a push rod linkage (10) that is positively coupled to the hinge arm (4) at one end and that is communicating with the pivot axis (20) of the bridge plate (3) at the other end for rotation of said pivot axis (20).

3. The wheelchair lift apparatus as set forth in claim 1, characterized in that the linkage system (14) incorporates an abutment rod (31) that is displaceable by the abutment cam (22) disposed on the pivot axis (20) upon rotation of the pivot axis (20).

4. The wheelchair lift apparatus as set forth in claim 3, characterized in that the abutment rod (31) is displaceable against the force of a spring (33).

5. The wheelchair lift apparatus as set forth in claim 3, characterized in that the abutment rod (31) is in communication with the connecting arm (42).

6. The wheelchair lift apparatus as set forth in claim 1, characterized in that the positive guide (43) is configured in a crank-like fashion with a guiding groove (44) for receiving the guide member (45) of the hand rail (40).

7. The wheelchair lift apparatus as set forth in claim 1, characterized in that the crank (43) is arc-shaped and is in particular configured in the shape of a quarter of a circle.

8. The wheelchair lift apparatus as set forth in claim 1, characterized in that the guide groove (44) in the crank extends in the shape of an elongated Z, the guide member resting in the respective leg (44a, 44b) located at one of the ends in the respective end position.

9. The wheelchair lift apparatus as set forth in claim 1, characterized in that the connecting arm (42), which is connected to the abutment rod, is biased against the force of at least one spring (48) upon displacing the abutment rod (31) by rotating the pivot axis (20) so that the hand rail (40) is folded in against the at least one spring (48).

10. The wheelchair lift apparatus as set forth in claim 1, characterized in that the platform (2) comprises a pivotal ramp steel plate (60) at the end opposite the bridge plate (3), a drive motor (61) being provided for pivoting the ramp steel plate (60).

11. The wheelchair lift apparatus as set forth in claim 10, characterized in that the platform (2) comprises on either side a beam (2a, 2b), to either of which there is attached a respective one of the hinge arms (4), the ramp steel plate (60) being pivotally carried by the beams (2a, 2b).

12. The wheelchair lift apparatus as set forth in claim 11, characterized in that the drive motor (61) disposed on the beam (2a) comprises a shaft (65) with a thread, the ramp steel plate (60) comprising, corresponding thereto, a female thread (61b) for receiving the threaded shaft so that, upon rotation of the shaft, the ramp steel plate (60) is displaceable parallel to its longitudinal axis, said threaded shaft (65) abutting the limit stop of the female thread (61b) after the ramp steel plate (60) has been displaced a determined length, said ramp steel plate (60) being pivoted into the horizontal position by the drive motor (61) when the threaded shaft (65) is being rotated further.

13. The wheelchair lift apparatus as set forth in claim 10, characterized in that the outward pivotal movement occurs against the force of a spring (70), in particular of a spiral spring.
